(19) United States
(12) Patent Application Publication
(10) Pub. No.: US 2026/0105474 A1
(43) Pub. Date: Apr. 16, 2026

(54) TAXONOMIC PREDICTION MODEL FOR CYBERSECURITY TRANSACTIONS

(71) Applicant: Optiv Security Inc., Denver, CO (US)

(72) Inventors: Kelsey Blackett, Castle Pines, CO (US); Todd Perrault, Kirkland, WA (US); Chris Gilstrap, Lee’s Summit, MO (US); Jonathan Semeyn, Overland Park, KS (US); Cheryl Van Voorhees, Erie, CO (US); Woodrow Brown, Padenghe sul Garda (IT)

(21) Appl. No.: 19/355,818

(22) Filed: Oct. 10, 2025

Related U.S. Application Data
(60) Provisional application No. 63/707,474, filed on Oct. 15, 2024.

(51) Int. Cl. G06Q 30/0202; G06Q 30/0204; G06Q 30/0601

(52) U.S. Cl. CPC G06Q 30/0202; G06Q 30/0204; G06Q 30/0631

(57) ABSTRACT

A method includes storing past transaction information related to cybersecurity products or services sold to a plurality of customers, associating individual transactions from the past transaction information with respective cybersecurity categories in a cybersecurity taxonomy, training a taxonomic prediction model to predict one or more next cybersecurity categories from which one or more customers of the plurality of customers are likely to purchase cybersecurity products or services based, at least in part, on the past transaction information and associated cybersecurity categories, using the taxonomic prediction model to predict the one or more next cybersecurity categories from which a first customer is likely to make a purchase, and displaying, in a single user interface, a category heatmap including a cybersecurity landscape for the first customer, the cybersecurity landscape including status indications for a plurality of cybersecurity categories including a recommended cybersecurity category generated by the taxonomic prediction model.

### CROSS-REFERENCE TO RELATED APPLICATIONS

This application claims the benefit of U.S. Provisional App. No. 63/707,474, filed Oct. 15, 2024, for TAXONOMIC PREDICTION MODEL FOR CYBERSECURITY TRANSACTIONS, which is incorporated herein by reference in its entirety for all purposes.

### TECHNICAL FIELD

The present disclosure relates generally to prediction models and more specifically to methods and systems for providing a taxonomic prediction model for cybersecurity transactions.

### BACKGROUND

Knowing which products are likely to be purchased next by a customer is critical to growing sales revenue. However, providing accurate recommendations to sales representatives regarding selling opportunities is a challenge. For example, the fact that company A has purchased products X and Y in the past does not necessarily mean that company B, which has purchased product X, will be interested in purchasing product Y. A customer's purchases are driven by many factors, including, for instance, the maturity of the customer's business. Predictive modeling at a SKU-to-SKU level is frequently ineffective and results in inaccurate recommendations and wasted selling opportunities.

### SUMMARY

The present disclosure solves the problems of conventional approaches by providing a technique for organizing and aggregating internal and external data into a framework from which a prediction model can identify opportunities for selling cybersecurity products or services. According to one aspect, a method includes storing past transaction information related to cybersecurity products or services sold to a plurality of customers. The method also includes associating individual transactions from the past transaction information with respective cybersecurity categories corresponding to categories of cybersecurity products or services in a cybersecurity taxonomy. The method further includes training a taxonomic prediction model, such as a neural network, to predict one or more next cybersecurity categories from which one or more customers of the plurality of customers are likely to purchase cybersecurity products or services based, at least in part, on the past transaction information and associated cybersecurity categories. In addition, the method includes using the taxonomic prediction model to predict the one or more next cybersecurity categories from which a first customer is likely to make a purchase. Finally, the method includes displaying, in a single user interface, a category heatmap including a cybersecurity landscape for the first customer. The cybersecurity landscape includes status indications for a plurality of cybersecurity categories, the status indications including a status indication for at least one recommended category from which to offer a purchase opportunity to the first customer based on the one or more next cybersecurity categories from which the first customer is predicted to make a purchase by the taxonomic prediction model.

In some examples, the status indications include a status indication for at least one of: a won category corresponding to a cybersecurity category for which at least one purchase of a cybersecurity product has been made by the first customer, a lost category corresponding to a cybersecurity category for which at least one cybersecurity product was offered to the first customer but did not result in a purchase, and/or a whitespace category corresponding to a cybersecurity category for which cybersecurity products or services have not been offered to, nor purchases made, by the first customer.

In certain configurations, the past transaction information includes maturity levels of the plurality of customers, and training the taxonomic prediction model includes training the taxonomic prediction model to predict the one or more next cybersecurity categories from which the one or more customers of the plurality of customers are likely to purchase the cybersecurity products or services based, at least in part, on the past transaction information and the associated cybersecurity categories, as well as the maturity levels of the plurality of customers. The method also includes providing a maturity level of the first customer to the taxonomic prediction model.

In some implementations, the method further includes displaying, in the single user interface, category heatmaps including cybersecurity landscapes for multiple customers including the first customer, the cybersecurity landscapes including status indications for a plurality of cybersecurity categories, the status indications including, for each of the multiple customers, one or more of: a status indication for at least one won category, a status indication for at least one lost category, a status indication for at least one whitespace category, and/or a status indication for at least one recommended category based on the one or more next cybersecurity categories from which the multiple customers are predicted to make a purchase by the taxonomic prediction model.

In various embodiments, the past transaction information includes internal past transaction information for products sold by a first company and external past transactions sold by one or more other companies, the external past transaction information being stored in a separate database from the internal past transaction information. The external past transaction information may be aggregated by one or more third parties.

In some examples, in response to selection by a user of a status indication for a recommended category, the method includes displaying at least one of a recommended vendor or a recommended product of a vendor associated with the recommended category. In other examples, the method includes, in response to selection by a user of a status indication for at least one won category associated with the first customer, displaying information related to the at least one purchase of the cybersecurity product made by the first customer.

In still other examples, the method includes, in response to selection by a user of a category in the single user interface, displaying a list of other customers that have made purchases associated with the selected category. In certain implementations, the method includes selecting the other customers and/or ordering the other customers in the list for display based on a similarity to the first customer. The similarity may include one or more of maturity, size, and territory.

According to another aspect, a system includes a database configured to store past transaction information related to cybersecurity products or services sold to a plurality of customers. The system also includes at least one processor configured to associate individual transactions from the past transaction information with respective cybersecurity categories corresponding to categories of cybersecurity products or services in a cybersecurity taxonomy, train a taxonomic prediction model to predict one or more next cybersecurity categories from which one or more customers of the plurality of customers are likely to purchase cybersecurity products or services based, at least in part, on the past transaction information and associated cybersecurity categories, and predict, using the taxonomic prediction model, the one or more next cybersecurity categories from which a first customer is likely to make a purchase. The system further includes a display interface configured to display, in a single user interface, a category heatmap including a cybersecurity landscape for the first customer, the cybersecurity landscape including status indications for a plurality of cybersecurity categories, the status indications including a status indication for at least one recommended category from which to offer a purchase opportunity to the first customer based on the one or more next cybersecurity categories from which the first customer is predicted to make a purchase by the taxonomic prediction model. The status indications may further include at least one of a status indication for at least one won category corresponding to a cybersecurity category for which at least one purchase of a cybersecurity product has been made by the first customer, a status indication for at least one lost category corresponding to a cybersecurity category for which at least one cybersecurity product was offered to the first customer but did not result in a purchase, and a status indication for a whitespace category corresponding to a cybersecurity category for which cybersecurity products or services have not been offered to, nor purchases made, by the first customer.

In still another aspect, a computer-readable storage medium stores program instructions that, when executed by one or more processors, cause the one or more processors to perform a method. The method includes storing past transaction information related to cybersecurity products or services sold to a plurality of customers. The method also includes associating individual transactions from the past transaction information with respective cybersecurity categories corresponding to categories of cybersecurity products or services in a cybersecurity taxonomy. The method further includes training a taxonomic prediction model, such as a neural network, to predict one or more next cybersecurity categories from which one or more customers of the plurality of customers are likely to purchase cybersecurity products or services based, at least in part, on the past transaction information and associated cybersecurity categories. In addition, the method includes using the taxonomic prediction model to predict the one or more next cybersecurity categories from which a first customer is likely to make a purchase. Finally, the method includes displaying, in a single user interface, a category heatmap including a cybersecurity landscape for the first customer. The cybersecurity landscape includes status indications for a plurality of cybersecurity categories, the status indications including a status indication for at least one recommended category from which to offer a purchase opportunity to the first customer based on the one or more next cybersecurity categories from which the first customer is predicted to make a purchase by the taxonomic prediction model.

### BRIEF DESCRIPTION OF THE DRAWINGS

The accompanying figures are provided by way of illustration and not by way of limitation. The foregoing aspects and other features of the disclosure are explained in the following description, taken in connection with the accompanying example figures relating to one or more embodiments, in which:

FIG. 1A is a schematic diagram of a system for recommending selling opportunities according to an embodiment;

FIG. 1B is an example of a taxonomy according to an embodiment;

FIG. 1C is an example of a SKU-to-category mapping according to an embodiment;

FIGS. 2, 3, and 4 illustrate views of a category heatmap and associated reports according to an embodiment;

FIG. 5 is a flowchart of a method for recommending selling opportunities according to an embodiment; and

FIG. 6 is a schematic diagram of a system for implementing aspects of the disclosed technology according to an embodiment.

### DETAILED DESCRIPTION

In the following description, specific details are set forth in order to provide a thorough understanding of embodiments of the application. However, it will be apparent that various embodiments may be practiced without these specific details. The figures and description are not intended to be restrictive but are offered by way of illustration. Various changes may be made in the function and arrangement of elements without departing from the spirit and scope of the application as set forth in the appended claims. Unless otherwise defined, all technical terms used herein have the same meaning as commonly understood by one of ordinary skill in the art to which this disclosure belongs.

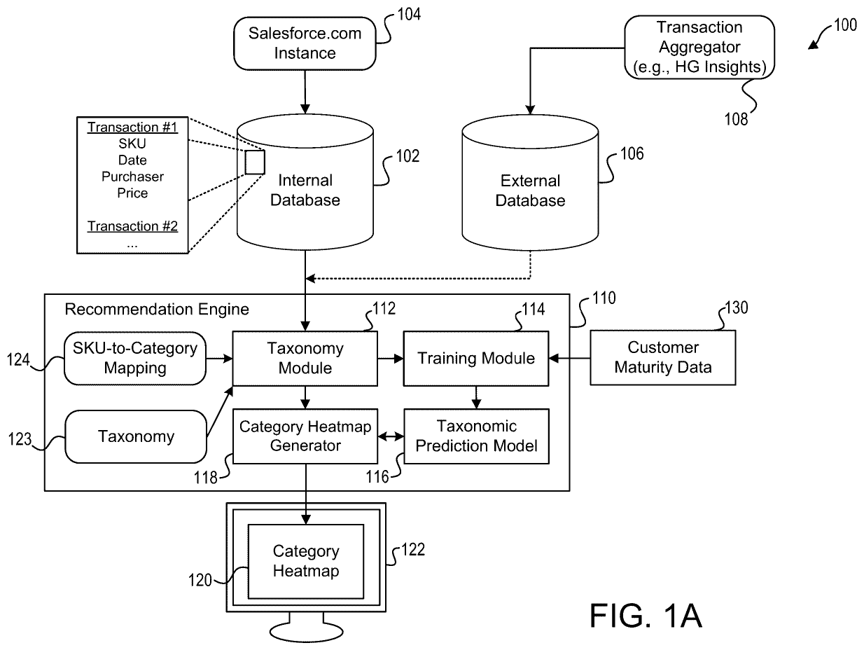

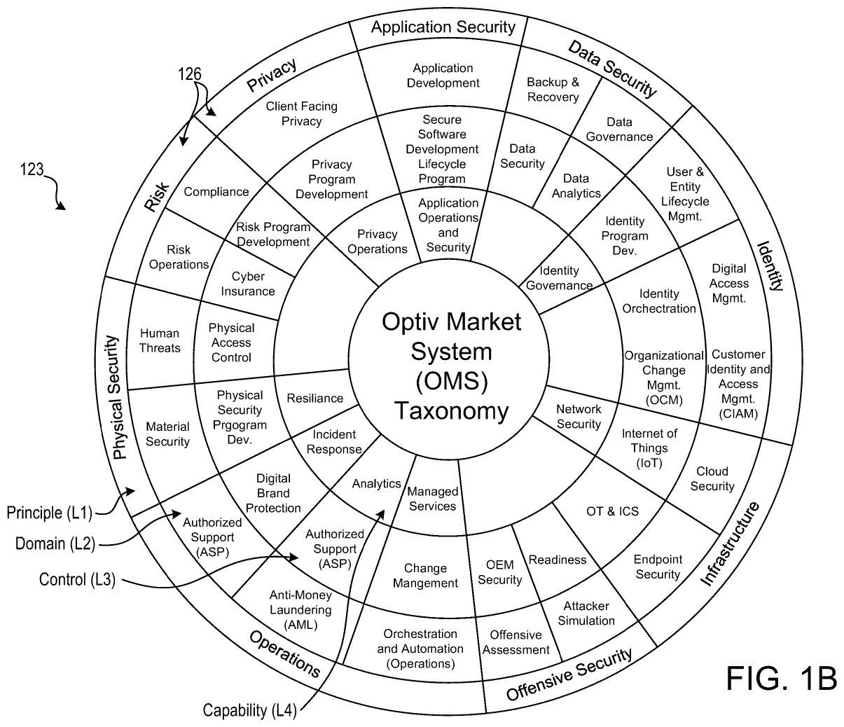

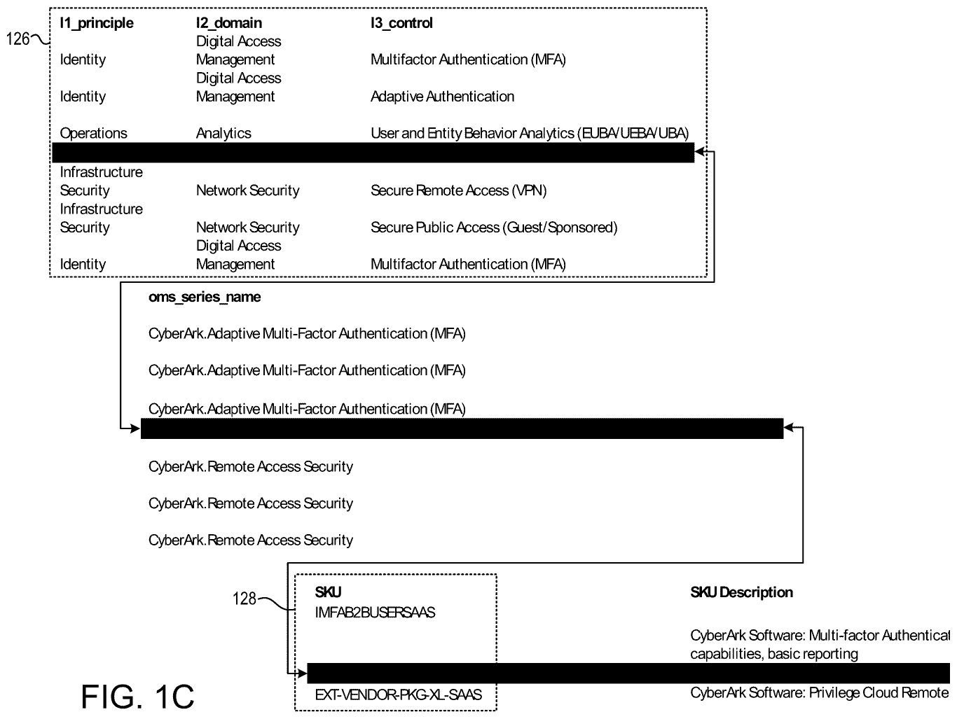

FIG. 1A is a schematic diagram of a system 100 for predicting and recommending selling opportunities to one or more sales representatives. In some embodiments, the system 100 includes an internal database 102 for storing past transaction information related to products sold by a particular company to a set of customers. The products may include cybersecurity products or services, although the disclosure is not limited in this respect. The past transaction information may be obtained, for example, from a salesforce.com instance 104 used by the company, which may contain records of all company sales over a particular time period. The past transaction information may include various data for each transaction, such as, without limitation, a stock keeping unit (SKU) or other product or service identifier, a transaction date, a purchaser, a purchase price, and/or the like.

In some configurations, the system 100 may access data stored in an external database 106 of past transaction information maintained by at least one third-party transaction aggregator 108, such as HG Insights of Santa Barbara, California. The external database 106, which may be separate from the internal database 102, may include past transaction information for companies other than the company maintaining the internal database 102, which may be obtained by the transaction aggregator 108 from a variety of sources, including, without limitation, web traffic and public contracting. The past transaction information stored in the external database 106 may include various data for each transaction, such as, without limitation, a seller, a SKU or other product or service identifier, a transaction date, a purchaser, a purchase price, and/or the like.

The system 100 may further include a recommendation engine 110 for recommending to a sales representative one or more next products or services to offer to a customer. The recommendation engine 110 may access the past transaction information stored in the internal database 102 and/or the external database 106. The recommendation engine 110 may be implemented using any suitable combination of hardware, software, and/or firmware. For example, certain components of the recommendation engine 110 may be embodied as software modules stored in a memory that are executed by one or more processors. The illustrated components need not be embodied in a single device but may be implemented at least partially in the cloud or using any suitable distributed computer architecture.

The recommendation engine 110 may include various components, such as, without limitation, a taxonomy module 112, a training module 114, and a taxonomic prediction model 116, as described in greater detail hereafter. The recommendation engine 110 may further include a category heatmap generator 118, which is used to generate a category heatmap 120 for display on a display device 122, such as a computer monitor, tablet, or smartphone display.

In operation, the taxonomy module 112 receives past transaction information related to cybersecurity or other products or services sold to a plurality of customers from the internal database 102 and/or the external database 106. The past transaction information may have a stock keeping unit (SKU) granularity or an equivalent identifier for services. In other words, each of the transactions in the past transaction information may relate to or identify a particular SKU or SKUs. As used herein, SKU may be broadly construed to encompass both products and services.

In some embodiments, the taxonomy module 112 associates individual transactions from the past transaction information with respective cybersecurity categories (also referred to in the art as cybersecurity domains) from a taxonomy 123 (an example of which is shown in FIG. 1B) used to classify different types of cybersecurity products or services. Examples of cybersecurity taxonomies include, without limitation, the National Institute of Standards (NIST) Cybersecurity Framework, ISO 27001 and 27002, the Center for Internet Security (CIS) framework, and the Optiv Market System (OMS) taxonomy used by Optiv Security, Inc. As an example, the NIST Cybersecurity Framework includes five high-level elements or domains, i.e., identify, protect, detect, respond, and recover.

As shown in FIG. 1B, the taxonomy 123 may include various cybersecurity categories 126 (or other taxonomic levels). For example, the categories 126 of the outermost level (L1) may be referred to as a “principles,” while the categories 126 of the next levels (L2-L4) may be referred to as “domains,” “controls,” and “capabilities,” respectively. As used herein, the a category 126 may be broadly construed to include any taxonomic level of a cybersecurity taxonomy or framework that has a lower level of granularity than a SKU granularity. Further, a “lower” level of granularity means that the category encompasses a plurality of SKUs. For example, in the case of the NIST Cybersecurity Framework, a top-level element like “protect” could be considered a category 126 within the context of the present disclosure, whereas a capability like “incident response” is also an example of a category 126 in the illustrated Optiv Market System (OMS) taxonomy 123 of FIG. 1B.

All cybersecurity products or services can typically be classified within a particular category using one or more taxonomies 123. By definition, categories 126 represent a lower level of granularity than a SKU granularity, because multiple SKUs may be associated with a particular category. In some embodiments, a SKU may be associated with multiple domains. However, there are typically far fewer categories than skews.

While the OMS taxonomy 123 of FIG. 1B is illustrated as a circle with multiple levels containing different categories 126, any suitable representation may be used, such as a tree or directed graph. The taxonomy may be 123 may be stored or embodied in any suitable format for later access, such as an eXtensible Markup Language (XML) format, although the disclosure is not limited in this respect.

Referring again to FIG. 1A, in some embodiments, the taxonomy module 112 may access a SKU-to-category mapping 124 that associates individual transactions from the past transaction information in the internal database 102 and/or external database 106 with respective cybersecurity categories 126, as well as a representation of a taxonomy 123. The SKU-to-category mapping 124 may have been previously generated either manually or through an automated process and may be stored within a database, such as the internal database 102. FIG. 1C illustrates some entries in a SKU-to-category mapping 124, including various SKUs 128 being associated with categories 126 in a taxonomic hierarchy. For example, a transaction involving the “IMFAB2BUSERSAAS” SKU 128 may be associated with the “Identity,” “Digital Access Management,” and “Multifactor Authentication” categories 126 from the OMS taxonomy 123 of FIG. 1B.

As shown in FIG. 1A, the training module 114 may be used to train a taxonomic prediction model 116 to predict one or more next cybersecurity categories from which one or more customers are likely to purchase cybersecurity products or services based, at least in part, on the past transaction information and associated cybersecurity categories 126. As used herein, a taxonomic prediction model 116 is a prediction model that is trained to predict a taxonomic category, which has a lower level of granularity than a SKU granularity.

The taxonomic prediction model 116 may be implemented using a variety of artificial intelligence (AI) and/or machine learning (ML) systems, such as an artificial neural network (ANN). In some embodiments, the ANN may be a recurrent neural network (RNN), a convolutional neural network (CNN), a feedforward neural network (FNN), a long short-term memory network (LSTM), a multilayer perceptron (MLP), a modular neural network, or the like. In certain configurations, the TensorFlow® machine learning platform developed by Google may be used to implement the taxonomic prediction model 116.

The taxonomic prediction model 116 may be trained to predict, for instance, that if a customer has made one or more purchases within a first set of categories 126, the customer will be likely to make one or more purchases within a second set of categories 126. Accordingly, the taxonomic prediction model 116 may not necessarily be trained to predict purchases at a SKU level of granularity, although this could be implemented in some embodiments. Rather, the taxonomic prediction model 116 is trained to predict the next cybersecurity category 126 from which the customer is likely to make a purchase. The taxonomic prediction model 116 may be trained, in some embodiments, using a portion (e.g., 80%) of the past transaction information in the internal database 102 and/or external database 106, while the remaining portion (e.g., 20%) may be used for validation and refining of the taxonomic prediction model 116.

In certain configurations, the training module 114 may further train the taxonomic prediction model 116 with customer maturity data 130 relating to the maturity of the purchasing company/customer. In the cybersecurity context, maturity is typically a reference to the information technology (IT) maturity of the company, which has five levels according to the Capability Maturity Model Integration (CMMI) appraisal program administered by the CMMI institute: (1) initial, (2) managed, (3) defined, (4) quantitatively managed, and (5) optimizing. Each of the maturity levels is associated with particular characteristics of the company's IT department. For example, maturity level 1 is characterized by ad hoc or chaotic processes, where success often depends upon the competence or heroics of the employees in the organization rather than on the use of proven processes. By contrast, by maturity level 4, sub-processes contribute to overall performance, and they are controlled using statistical and other quantitative techniques, with performance measures being established for quality and performance.

Customers will purchase different products or services depending on the maturity level of their IT department. Therefore, training the taxonomic prediction model 116 with data 130 regarding maturity levels may more accurately predict the next cybersecurity category or categories 126 for purchase activity by the customer. Customer maturity data 130 may be obtained from third-party sources and/or derived from one or more of the number of years the company has been in business, the number of years the company has been a customer, the number of employees of the company, and/or other factors. In some embodiments, the customer maturity data 130 may be stored in the internal database 102 and/or external database 106.

After the taxonomic prediction model 116 is trained, the recommendation engine 110 will use the taxonomic prediction model 116 to predict the one or more next cybersecurity categories 126 from which a particular customer is likely to make a purchase. The recommendation engine 110 may then include the predicted category 126 or categories 126 in a report, such as a category heatmap 120, which may be generated by the category heatmap generator 118 for display on the display device 122. The category heatmap 120 provides guidance to a sales representative or a partner company regarding the next category or categories from which products or services should be selectively offered to the customer. In some implementations, the category heatmap 120 can also be utilized to inform broader strategic initiatives and may also be configured to share information directly with customers to provide tailored insights and recommendations, thereby guiding the customer through a progressive or staged cyber maturity journey. In additional embodiments, the category heatmap 120 may be further employed for automated or semi-automated processes beyond distribution of such information to sales representatives, partner entities or customers.

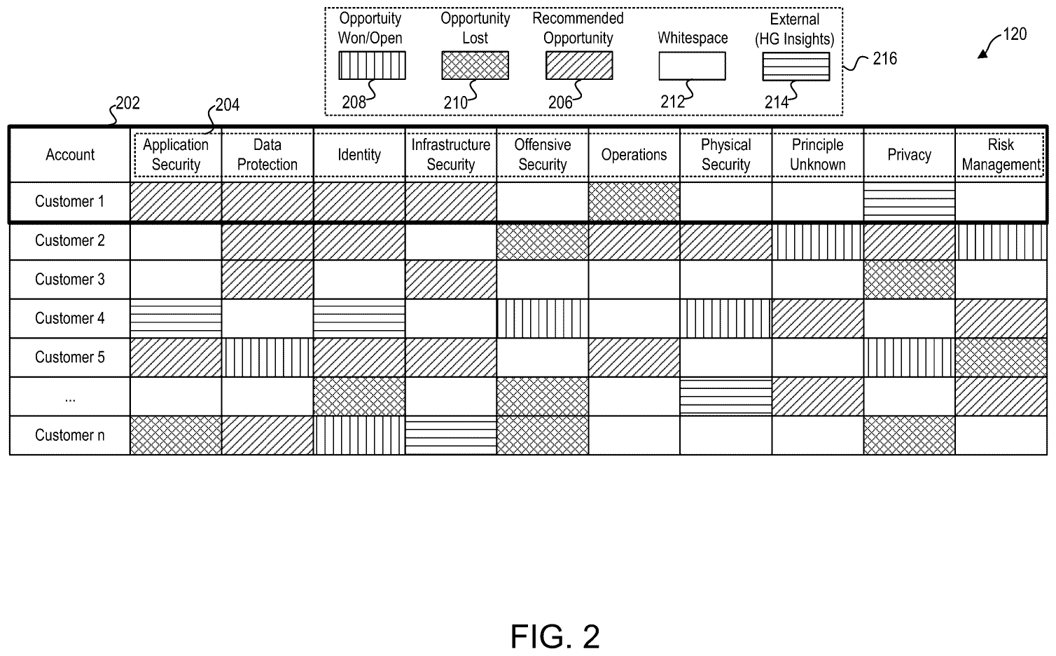

Referring to FIG. 2, in some embodiments, the category heatmap 120 may include, in a single graphical user interface (GUI), a cybersecurity landscape 202 for a particular customer or territory. In certain embodiments, the cybersecurity landscape 202 includes a set of cybersecurity categories 204 (or other taxonomic levels, such as domains, elements, or the like) with various status indications as described below. As used herein, a category 204 may be similar or identical to the categories 126 of FIG. 1B and may be broadly construed to include any taxonomic level of a cybersecurity taxonomy 123 or framework that has a lower level of granularity than a SKU granularity, i.e., encompasses more than one SKU.

The status indications associated with a category 204 may be color-coded, indicated by a pattern (as illustrated in FIG. 2), or designated by text, graphics, or any other suitable identifier. In some embodiments, the status indications may include one or more of:
1. a recommended indication 206 for one or more recommended categories 204 based on the next cybersecurity category 204 or categories 204 from which the customer is predicted to make a purchase by the taxonomic prediction model 116;
2. a won indication 208 for one or more won categories 204 corresponding to cybersecurity categories 204 for which at least one purchase of a cybersecurity product or service has been made by the customer;
3. a lost indication 210 for one or more lost categories 204 corresponding to cybersecurity categories 204 for which at least one cybersecurity product or service was offered to the customer but did not result in a purchase (e.g., within a predetermined time interval);
4. a whitespace indication 212 for one or more whitespace categories 204 corresponding to cybersecurity categories 204 for which cybersecurity products or services have not been offered to, nor purchases made, by the customer; and/or
5. an external indication 214 for one or more categories 204 from which purchases were recorded by the transaction aggregator 108 and stored in the external database 106.
   Other status indications (not shown) may be provided, such as, without limitation, an open indication corresponding to one or more open categories 204 for which offers of cybersecurity products or services in the category have recently been made to the customer but insufficient time has passed to register a lost sale. In certain embodiments, an open indication may be combined with a won indication 208, as shown in FIG. 2. Other combinations may be made and/or additional or fewer status indications provided in various configurations. As illustrated, a legend 216 may be provided to assist the user in identifying particular types of status indications.

The categories 204 shown in the cybersecurity landscape 202 may not be all of the categories 204 within a particular taxonomy 123 or framework. For example, the Optiv Market System (OMS) taxonomy has thirty-eight second level (L2) categories or “domains.” In some embodiments, a user may be able to scroll the category heatmap 120 left or right (or up or down depending on which axis the categories 204 are displayed) to reveal additional categories 204 or additional accounts or customers. In certain embodiments, the most commonly used categories 204 or the categories 204 for which the most sales have been made will be selected for initial display in a category heatmap 120 that cannot display all categories 204 simultaneously.

As shown in FIG. 2, the category heatmap 120 may include cybersecurity landscapes 202 for multiple customers. For example, a sales representative may be primarily interested in recommendations for the next category 204 for Customer 1. However, cybersecurity landscapes 202 for Customers 2 through n may be provided for comparison. In some embodiments, the other customers may be selected to have a similar maturity level or size or be part of the same territory. In certain embodiments, Customers 2 through n may be ordered according to similarity with Customer 1 with the most similar customers being displayed nearest to Customer 1.

All or some of the elements of the category heatmap 120 may be selectable to drill down and display additional information. For example, selecting a customer name may result in the display of a report of sales to the customer, which can be filtered by date or category. Likewise, selecting one or more of the status indications in the legend 216 may filter the customers in the category heatmap 120 to only show those customers with categories 204 marked with one of the selected indications.

The above-described techniques improve the functioning the system 100 over conventional approaches, reducing network accesses to the internal database 102 and/or external database 103 and reducing the need for network bandwidth and improving system efficiency. Furthermore, the described recommendation engine 110 is more accurate than conventional techniques that use predictive modeling at a SKU-to-SKU level, resulting in fewer lost opportunities and measurable increases in wins. Overall, the system 100 greatly improves the field of transaction recommendations and predictive modeling.

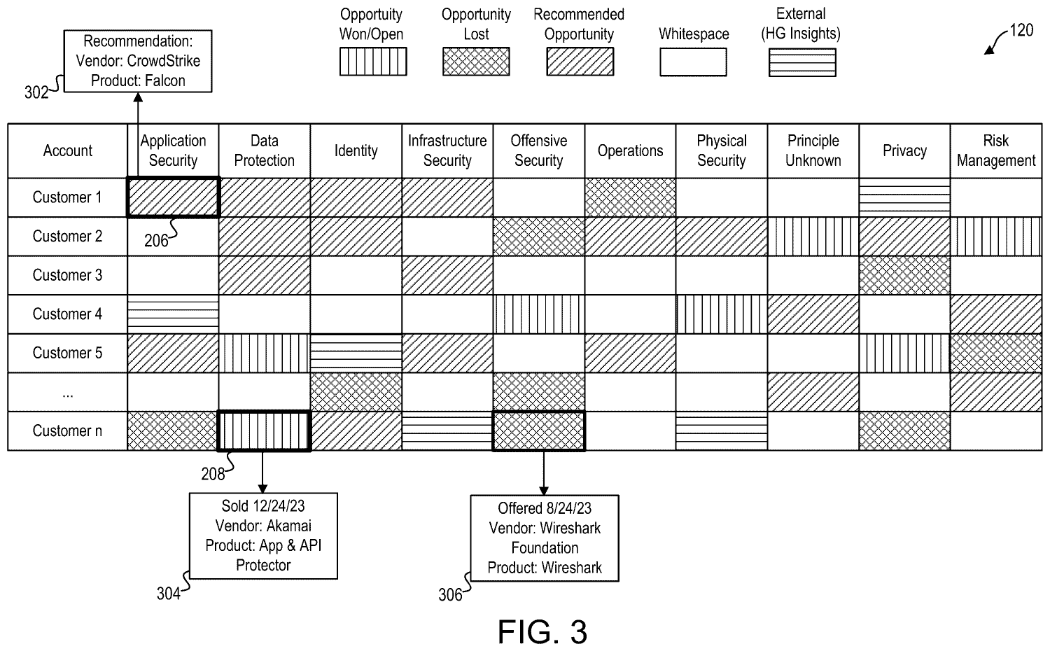

FIG. 3 illustrates the effect of selecting certain other elements of the category heatmap 120. For example, selecting a recommended indication 206 may display a recommendation 302 for a particular vendor and/or product or service of the vendor to offer to the customer. The recommendation 302 may be generated, in some embodiments, by the taxonomic prediction model 116 or a different prediction model trained for predicting SKUs that a customer will likely purchase based on, e.g., the category 204, the customer's maturity level, seasonal information, and/or any other relevant information. In other embodiments, the recommendation 302 may be based on the most sold products or services within the category 204, the products or services with the highest profit margin, or other factors. In some embodiments, the recommendation 302 may provide additional information, such as “28 customers have purchased CrowdStrike Falcon in the last 30 days.” The recommendation 302 may include graphs, charts, tables, or other information that may be relevant to a sales representative in selecting a selling opportunity for a particular customer.

As another example, selecting a won indication 208 may display a report 304 of product(s) or service(s) from the associated category 204 sold to a particular customer or to all or a subset of customers. The report 304 may include information regarding past transactions from the internal database 102 and/or the external database 106, and may be ordered or filtered by sales revenue, profit margin, transaction date, or any other criteria.

As yet another example, selecting a lost indication 208 may display a report 306 of opportunities that did not result in a sale of products or services to a particular customer (or subset of customers). An opportunity may be considered lost where the customer turned down an offer or did not accept an offer within a particular time period. In certain embodiments, the report 306 may include details of the failed transaction including quantity, price, customer feedback, or other relevant information.

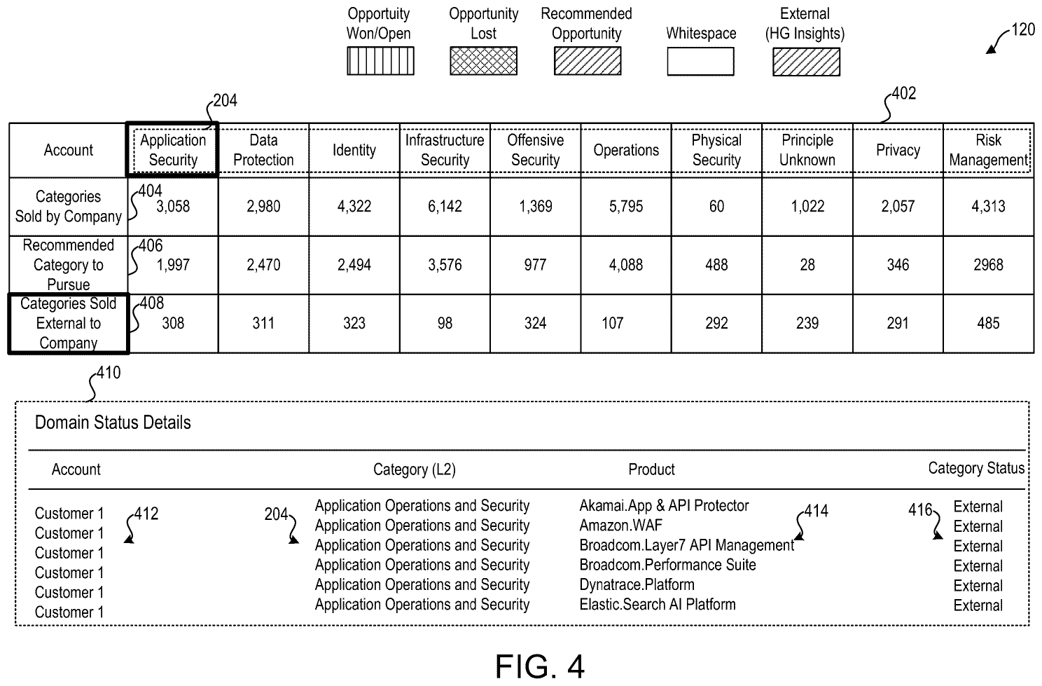

FIG. 4 illustrates a summary 402 of the category heatmap 120, which may be displayed, in some embodiments, in response to a user selecting one of the categories 204 (e.g., “Application Security”) or in response to another user selection or command (e.g., scrolling to the end of the list of clients/customers). The summary 402 may include, for instance, the categories 204 shown in FIGS. 1-2.

For each category 204 or a subset thereof, the summary 402 may include a number of category totals, such as, without limitation:
1. a category total 404 corresponding to the number of categories 204 from which products or services were sold by the company as represented by the past transaction information in the internal database 102;
2. a category total 406 corresponding to the number of recommended categories 204 as provided by the recommendation engine 110 of FIG. 1A; and/or
3. a category total 408 corresponding to the number of categories 204 sold external to the company, i.e., categories 204 for which products or services were sold by other companies as represented by the past transaction information in the external database 106.

In some embodiments, the categories 204 may be selectable to display a category status report 410, which may include, for each category 204, an identification 412 of the customer making a purchase from the selected category 204, the selected category 204 from which a purchase was made, an identification 414 of the product or service sold to the customer, and a category status 416. The category status 416 may correspond to any of the indicators 208-214 shown in FIG. 2.

The category status report 410 may be filterable, in certain embodiments, in response to the user selecting one of the category totals 404-408. For example, selecting the category total 408 may result in displaying only the transactions for categories 204 sold externally to the company (as shown in FIG. 4). Alternatively, selecting the category total 404 may result in filtering the list of transactions to display only those in won or open categories 204. Likewise, selecting the category total 406 may result in filtering the list of transactions to only display those recommended by the recommendation engine 110.

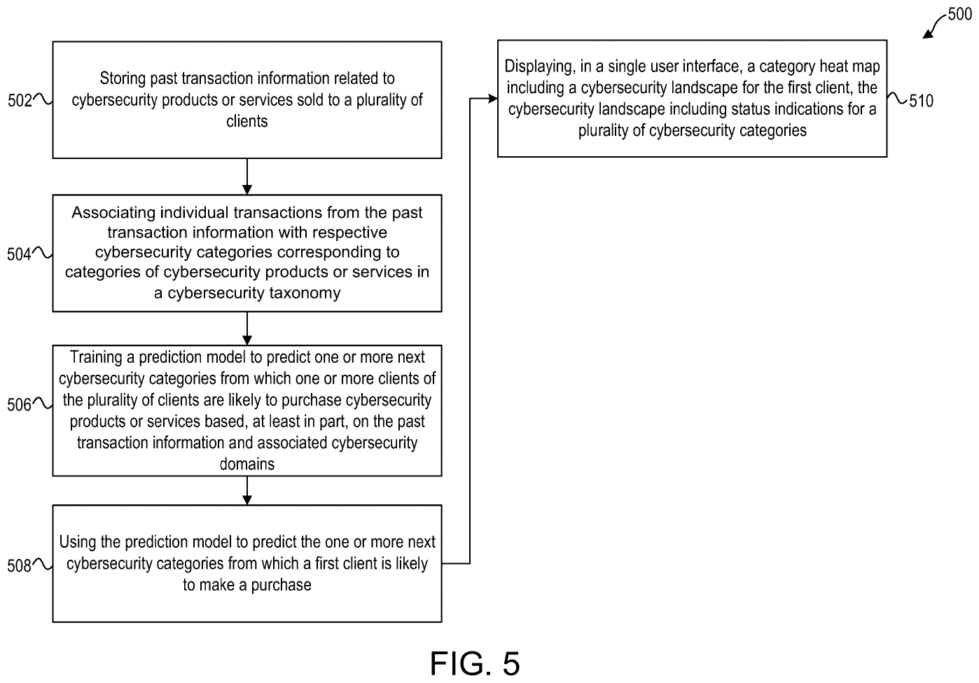

FIG. 5 is a flowchart of a method 500 for recommending selling opportunities. The method 500 may begin at step 502 by storing past transaction information related to cybersecurity products or services sold to a plurality of customers. The method 500 may continue at step 504 by associating individual transactions from the past transaction information with respective cybersecurity categories corresponding to categories of cybersecurity products or services in a cybersecurity taxonomy.

In some implementations, the method 500 may continue at step 506 by training a taxonomic prediction model, such as a neural network, to predict one or more next cybersecurity categories from which one or more customers of the plurality of customers are likely to purchase cybersecurity products or services based, at least in part, on the past transaction information and associated cybersecurity categories.

After the taxonomic prediction model has been trained, the method 500 may continue at step 508 by using the taxonomic prediction model to predict the one or more next cybersecurity categories from which a first customer is likely to make a purchase. The method 500 may also include, at step 510, displaying, in a single user interface, a category heatmap including a cybersecurity landscape for the first customer.

In some embodiments, the cybersecurity landscape includes status indications for a plurality of cybersecurity categories, the status indications including a status indication for at least one recommended category from which to offer a purchase opportunity to the first customer based on the one or more next cybersecurity categories from which the first customer is predicted to make a purchase by the taxonomic prediction model.

In certain implementations, the status indications further include at least one of: a won category corresponding to a cybersecurity category for which at least one purchase of a cybersecurity product has been made by the first customer, a lost category corresponding to a cybersecurity category for which at least one cybersecurity product was offered to the first customer but did not result in a purchase, and/or a whitespace category corresponding to a cybersecurity category for which cybersecurity products or services have not been offered to, nor purchases made, by the first customer.

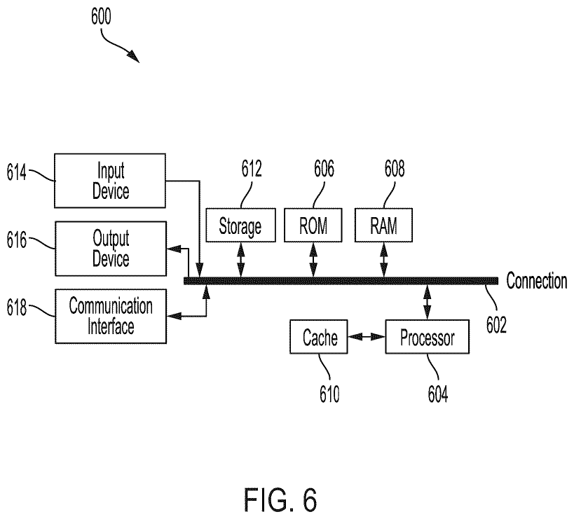

FIG. 6 is a schematic diagram of a system 600 for implementing aspects of the disclosed technology. In this example, the components of the system 600 are in electrical communication with each other using a connection 602, such as a bus. The system 600 includes a processor 604, such as a central processing unit (CPU). The connection 602 couples various system components to the processor 604, including, without limitation, a read only memory (ROM) 606 and a random-access memory (RAM) 608.

The system 600 may also include a cache 610 of high-speed memory connected directly with, in close proximity to, or integrated as part of the processor 604. The system 600 can copy data from the ROM 606, RAM 608, and/or a storage device 612 to the cache 610 for quick access by the processor 604. In this way, the cache 610 can provide a performance boost that avoids delays while waiting for data.

To enable user interaction with the system 600, an input device 614, which is in electrical communication with the connection 602, can represent any number of input mechanisms, such as a microphone for speech, a touch-sensitive screen for gesture or graphical input, a keyboard, a mouse, a motion input device, or the like. An output device 616, which is likewise in electrical communication with the connection 602, can be one or more of a number of output mechanisms known to those of skill in the art, such as a computer monitor, tablet, or smart phone display.

A communication interface 618, which is also in electrical communication with the connection 602, may facilitate communication with a network, such as the Internet. The communication interface 618 may be wired or wireless and may implement various standards, such as IEEE 802.11x. Communication over the communication interface 618 may conform to various protocols, including, without limitation, the Transmission Control Protocol/Internet Protocol (TCP/IP) and the Hypertext Transfer Protocol (HTTP).

The systems and methods described herein can be implemented in hardware, software, firmware, or combinations of hardware, software and/or firmware. In some examples, systems described in this specification may be implemented using a non-transitory computer readable medium storing computer executable instructions that when executed by one or more processors of a computer cause the computer to perform operations. Computer readable media suitable for implementing the control systems described in this specification include non-transitory computer-readable media, such as disk memory devices, chip memory devices, programmable logic devices, random access memory (RAM), read only memory (ROM), optical read/write memory, cache memory, magnetic read/write memory, flash memory, and application-specific integrated circuits. In addition, a computer-readable medium that implements a control system described in this specification may be located on a single device or computing platform or may be distributed across multiple devices or computing platforms.

One skilled in the art will readily appreciate that the present disclosure is well adapted to carry out the objects and obtain the ends and advantages mentioned, as well as those inherent therein. Changes and other uses will occur to those skilled in the art which are encompassed within the spirit of the present disclosure as defined by the scope of the claims.

No admission is made that any reference, including any non-patent or patent document cited in this specification, constitutes prior art. In particular, it will be understood that, unless otherwise stated, reference to any document herein does not constitute an admission that any of these documents forms part of the common general knowledge in the art in the United States or in any other country. Any discussion of the references states what their authors assert, and the applicant reserves the right to challenge the accuracy and pertinence of any of the documents cited herein. All references cited herein are fully incorporated by reference, unless explicitly indicated otherwise. The present disclosure shall control in the event there are any disparities between any definitions and/or description found in the cited references.

What is claimed is:

1. A method comprising:
storing past transaction information related to cybersecurity products or services sold to a plurality of customers;
associating individual transactions from the past transaction information with respective cybersecurity categories corresponding to categories of cybersecurity products or services in a cybersecurity taxonomy;
training a taxonomic prediction model to predict one or more next cybersecurity categories from which one or more customers of the plurality of customers are likely to purchase cybersecurity products or services based, at least in part, on the past transaction information and associated cybersecurity categories;
using the taxonomic prediction model to predict the one or more next cybersecurity categories from which a first customer is likely to make a purchase; and
displaying, in a single user interface, a category heatmap including a cybersecurity landscape for the first customer, the cybersecurity landscape including status indications for a plurality of cybersecurity categories, the status indications including a status indication for at least one recommended category from which to offer a purchase opportunity to the first customer based on the one or more next cybersecurity categories from which the first customer is predicted to make a purchase by the taxonomic prediction model, the status indications for at least one of:
a won category corresponding to a cybersecurity category for which at least one purchase of a cybersecurity product has been made by the first customer;
a lost category corresponding to a cybersecurity category for which at least one cybersecurity product was offered to the first customer but did not result in a purchase; and
a whitespace category corresponding to a cybersecurity category for which cybersecurity products or services have not been offered to, nor purchases made, by the first customer.

2. The method of claim 1, wherein:
the past transaction information includes maturity levels of the plurality of customers;
training the taxonomic prediction model includes training the taxonomic prediction model to predict the one or more next cybersecurity categories from which the one or more customers of the plurality of customers are likely to purchase the cybersecurity products or services based, at least in part, on the past transaction information and the associated cybersecurity categories, as well as the maturity levels of the plurality of customers; and
using the taxonomic prediction model includes providing a maturity level of the first customer to the taxonomic prediction model.

3. The method of claim 1, wherein the taxonomic prediction model includes a trained neural network.

4. The method of claim 1, wherein displaying further includes displaying, in the single user interface, category heatmaps including cybersecurity landscapes for multiple customers including the first customer, the cybersecurity landscapes including status indications for a plurality of cybersecurity categories, the status indications including, for each of the multiple customers, one or more of:
a status indication for at least one won category;
a status indication for at least one lost category;
a status indication for at least one whitespace category; and
a status indication for at least one recommended category based on the one or more next cybersecurity categories from which the multiple customers are predicted to make a purchase by the taxonomic prediction model.

5. The method of claim 1, wherein the past transaction information includes internal past transaction information for products sold by a first company and external past transaction information corresponding to products sold by one or more other companies, the external past transaction information being stored in a separate database from the internal past transaction information, wherein the external past transaction information is aggregated by one or more third parties.

6. The method of claim 1, further comprising:
in response to selection by a user of a status indication for a recommended category, displaying at least one of a recommended vendor or a recommended product of a vendor associated with the recommended category.

7. The method of claim 1, further comprising:
in response to selection by a user of a status indication for at least one won category associated with the first customer, displaying information related to the at least one purchase of the cybersecurity product made by the first customer.

8. The method of claim 1, further comprising:
in response to selection by a user of a first cybersecurity category in the single user interface, displaying a list of other customers that have made purchases associated with the first cybersecurity category.

9. The method of claim 8, further comprising selecting the other customers and/or ordering the other customers in the list for display based on a similarity to the first customer.

10. The method of claim 9, wherein the similarity includes one or more of maturity, size, and territory.

11. A system comprising:
one or more databases configured to store past transaction information related to cybersecurity products or services sold to a plurality of customers;
at least one processor configured to:
associate individual transactions from the past transaction information with respective cybersecurity categories corresponding to categories of cybersecurity products or services in a cybersecurity taxonomy;
train a taxonomic prediction model to predict one or more next cybersecurity categories from which one or more customers of the plurality of customers are likely to purchase cybersecurity products or services based, at least in part, on the past transaction information and associated cybersecurity categories; and
predict, using the taxonomic prediction model, the one or more next cybersecurity categories from which a first customer is likely to make a purchase; and
a display interface configured to display, in a single user interface, a category heatmap including a cybersecurity landscape for the first customer, the cybersecurity landscape including status indications for a plurality of cybersecurity categories, the status indications including a status indication for at least one recommended category from which to offer a purchase opportunity to the first customer based on the one or more next cybersecurity categories from which the first customer is predicted to make a purchase by the taxonomic prediction model, the status indications further including at least one of:
a status indication for at least one won category corresponding to a cybersecurity category for which at least one purchase of a cybersecurity product has been made by the first customer;
a status indication for at least one lost category corresponding to a cybersecurity category for which at least one cybersecurity product was offered to the first customer but did not result in a purchase; and
a status indication for at least one whitespace category corresponding to a cybersecurity category for which cybersecurity products or services have not been offered to, nor purchases made, by the first customer.

12. The system of claim 11, wherein:
the past transaction information includes maturity levels of the plurality of customers;
training the taxonomic prediction model includes training the taxonomic prediction model to predict the one or more next cybersecurity categories from which the one or more customers of the plurality of customers are likely to purchase the cybersecurity products or services based, at least in part, on the past transaction information and the associated cybersecurity categories, as well as the maturity levels of the plurality of customers; and
using the taxonomic prediction model includes providing a maturity level of the first customer to the taxonomic prediction model.

13. The system of claim 11, wherein the taxonomic prediction model includes a trained neural network.

14. The system of claim 11, wherein the display interface is further configured to display, in the category heatmap, cybersecurity landscapes for multiple customers including the first customer, the cybersecurity landscapes including status indications for a plurality of cybersecurity categories, the status indications including, for each of the multiple customers, one or more of:
a status indication for at least one won category;
a status indication for at least one lost category;
a status indication for at least one whitespace category; and
a status indication for at least one recommended category based on the one or more next cybersecurity categories from which the multiple customers are predicted to make a purchase by the taxonomic prediction model.

15. The system of claim 11, wherein the past transaction information includes internal past transaction information for products sold by a first company and external past transaction information for products sold by one or more other companies, the external past transaction information being stored in a separate database from the internal past transaction information, wherein the external past transaction information is aggregated by one or more third parties.

16. The system of claim 11, wherein the display interface is further configured, in response to selection by a user of a status indication for a recommended category, to display at least one of a recommended vendor or a recommended product of a vendor associated with the recommended category.

17. The system of claim 11, wherein the display interface is further configured, in response to selection by a user of a status indication for at least one won category associated with the first customer, to display information related to the at least one purchase of the cybersecurity product made by the first customer.

18. The system of claim 11, wherein the display interface is further configured, in response to selection by a user of a first cybersecurity category in the single user interface, to display a list of other customers that have made purchases associated with the first cybersecurity category.

19. The system of claim 18, wherein the display interface is further configured to select the other customers and/or order the other customers in the list for display based on a similarity to the first customer.

20. The system of claim 19, wherein the similarity includes one or more of maturity, size, and territory.

21. A computer-readable storage medium storing program instructions that, when executed by one or more processors, cause the one or more processors to perform a method comprising:
storing past transaction information related to cybersecurity products or services sold to a plurality of customers;
associating individual transactions from the past transaction information with respective cybersecurity categories corresponding to categories of cybersecurity products or services in a cybersecurity taxonomy;
training a taxonomic prediction model to predict one or more next cybersecurity categories from which one or more customers of the plurality of customers are likely to purchase cybersecurity products or services based, at least in part, on the past transaction information and associated cybersecurity categories;
using the taxonomic prediction model to predict the one or more next cybersecurity categories from which a first customer is likely to make a purchase; and
displaying, in a single user interface, a category heatmap including a cybersecurity landscape for the first customer, the cybersecurity landscape including status indications for a plurality of cybersecurity categories, the status indications including a status indication for at least one recommended category from which to offer a purchase opportunity to the first customer based on the one or more next cybersecurity categories from which the first customer is predicted to make a purchase by the taxonomic prediction model, the status indications for at least one of:
a won category corresponding to a cybersecurity category for which at least one purchase of a cybersecurity product has been made by the first customer;
a lost category corresponding to a cybersecurity category for which at least one cybersecurity product was offered to the first customer but did not result in a purchase; and
a whitespace category corresponding to a cybersecurity category for which cybersecurity products or services have not been offered to, nor purchases made, by the first customer.
